(19) United States
(12) Patent Application Publication
(10) Pub. No.: US 2012/0191323 A1
(43) Pub. Date: Jul. 26, 2012

(54) INJECTOR EMULATION DEVICE

(75) Inventors: Nick Warner, Cambridgeshire (GB); Trevor Fletcher, Leicestershire (GB)

(73) Assignee: T Baden Hardstaff Ltd, Nottingham (GB)

(21) Appl. No.: 13/256,109

(22) PCT Filed: Mar. 12, 2010
(86) PCT No.: PCT/GB10/00451

§ 371 Date: Feb. 7, 2012

(30) Foreign Application Priority Data
Mar. 13, 2009 (GB) 0904372.0

(51) Int. Cl. F02D 41/30

(52) U.S. Cl. 701/104

(57) ABSTRACT

An injector emulation device for incorporation into a multiple fuel engine control system including a first control device (4) configured to operate a plurality of fuel injectors (10) to inject a first fuel into selected cylinders (8) of the engine (6) when the system is operating on the first fuel only and a second control device (54) arranged to operate, instead of the first control device (4), said plurality of injectors (10) to inject said first fuel when the system operates in multifuel mode, said first control device being connected to an injector emulation device for operation during said multifuel mode. The injector emulation device includes an electrical load device (157) arranged to mimic the electrical load characteristic of the injector (10) being emulated and further including electronic means which mimic the inductance and flyback characteristics of the injector (10) being emulated.

The present invention relates to an injector emulation device which is particularly, but not exclusively, for use in a dual fuel operating system for a vehicle engine.

We have developed a dual fuel operating system for a vehicle engine which is currently the subject of pending PCT patent application number PCT/GB2008/003188.

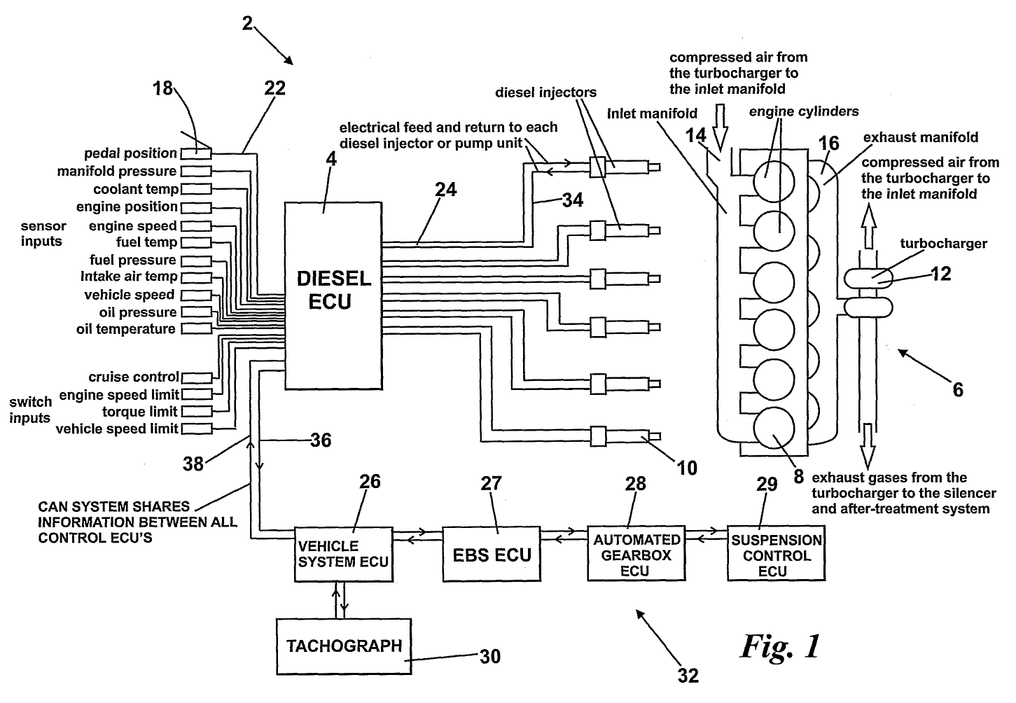

This operating system is described below with reference to FIGS. 1 to 4, in which:

FIG. 1 is a schematic representation of a diesel ECU forming part of a known engine designed to be fuelled by diesel only;

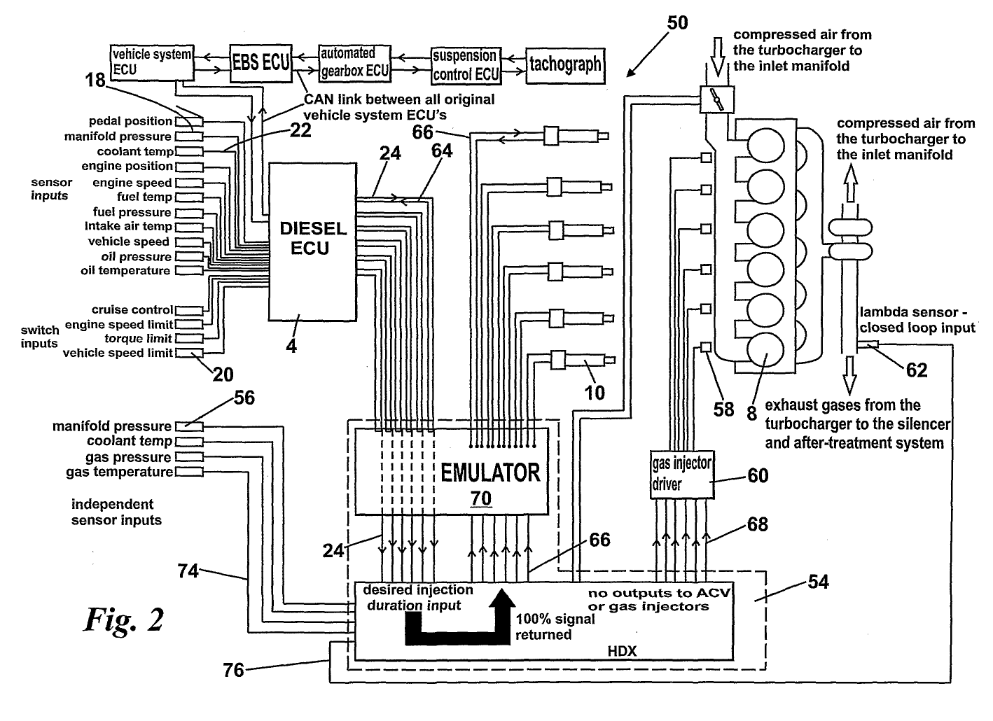

FIG. 2 is a schematic representation of an engine assembly according to an embodiment of the invention described in PCT patent application number PCT/GB2008/003188;

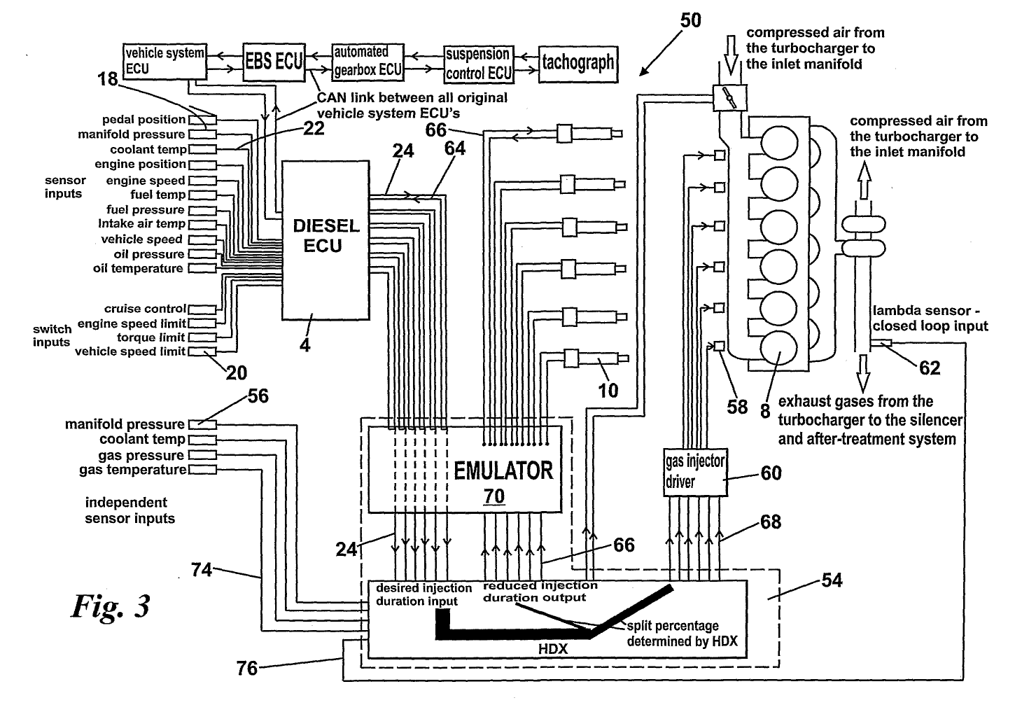

FIG. 3 is a schematic representation of the engine assembly of FIG. 2 operating in second mode;

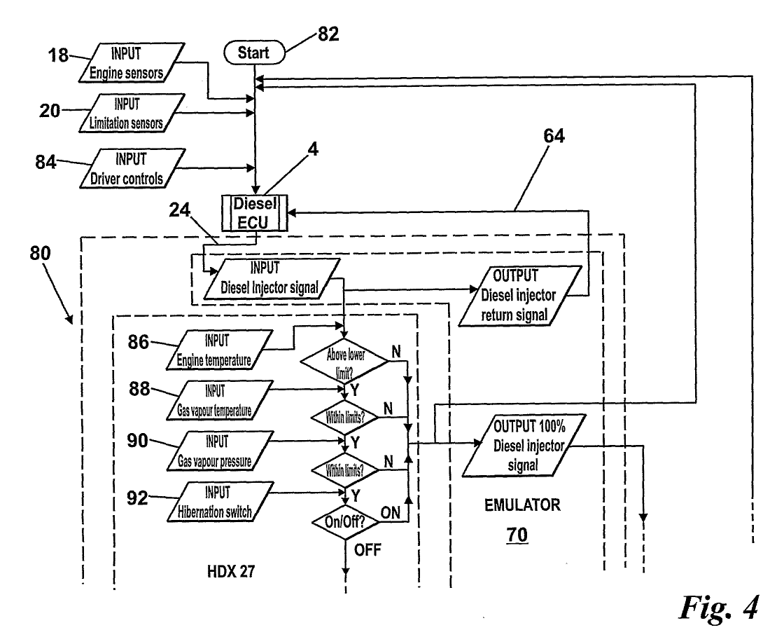

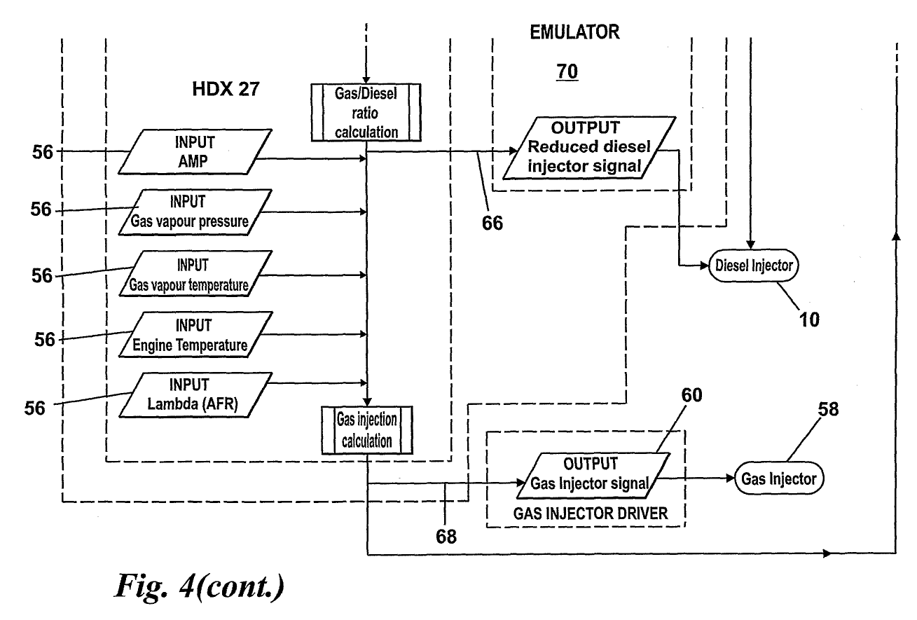

FIG. 4 is a flow chart showing operation of the engine assembly of FIGS. 2 and 3.

Referring to FIG. 1, a known diesel engine assembly is designated by the reference numeral 2. The engine assembly comprises a diesel control unit (ECU) 4 controlling engine 6. The ECU 4 is designed by an Original Equipment Manufacturer to enable the engine 6 to run on diesel as efficiently as possible taking into account various parameters that could affect the power requirements and fuel requirements of the engine 6. The engine may be of any suitable kind, but in this example, the engine is a common rail injector engine comprising six cylinders 8, and six diesel injectors 10. The engine 6 further comprises an inlet manifold 14 and an exhaust manifold 16.

The engine 6 in this example further comprises a turbo charger 12 for enhancing the performance of the engine in a known manner. During operation of the engine 6, compressed air from the turbo charger 12 is drawn into the engine via an inlet manifold 14 into the cylinders 8. The injectors 10 each inject diesel into the cylinders. The amount of fuel injected into the engine by each injector 10, and the timing of injection of the fuel by each injector is controlled by the ECU 4. The diesel mixes with the air in a known manner and explodes during the compression cycle of the engine 6, in order to provide power to power the engine 6. After compression, exhaust gases enter exhaust manifold 16, which gases contain a mixture of fuel and air. The exhaust gases are directed by the exhaust manifold 16 to a silencer and after-treatment system (not shown).

The diesel ECU 4 controls operation of a plurality of first sensors 18 which are operatively connected to the ECU 4. The first sensors each sense a particular variable parameter such as: pedal position; manifold pressure; coolant temperature; engine position; engine speed; fuel temperature; fuel pressure; intake air temperature; vehicle speed; oil pressure; oil temperature etc.

The diesel ECU 4 is also operatively connected to a plurality of switches 20 which control parameters such as cruise speed; engine speed; torque and vehicle speed limit. These switches also transmit signals to the diesel ECU 4 dependent on a limit set for a particular variable.

The diesel ECU 4 thus comprises a master unit and each of the sensors 18, switches 20 and injectors 10 are slave units controlled by the master ECU 4.

The diesel ECU 4 comprises a signal receiver (not shown) for receiving first input signals 22 from the first sensors 18 and switches 20. The value of each first input signal 22 is dependent on the variable being sensed. In this example, the first input signals 22 are either pulse width modulated or analogue, and the width of the pulse or level of voltage is dependent on the value of the variable being sensed. The diesel ECU 4 will receive the input signal 22 and will transmit a first output signal 24 to each of the injectors 10 dependent on the value of each of the variables sensed. Each first output signal 24 determines the amount of diesel injected into the engine 6 and also the time relative to the cycle of the engine at which the diesel is injected into the engine.

The Original Equipment Manufacturer develops an engine map which is a three-dimensional data array which enables the diesel ECU 4 to determine appropriate amounts of diesel to be injected into the engine and the timing of such injection, depending on all parameters measured. This ensures that the engine runs as efficiently as possible given the prevailing conditions.

The diesel ECU also has a control input to other electrical components in the engine assembly 2. In this example, the engine assembly further comprises a vehicle system ECU 26, and electronic brake system ECU 27, an automated gear box ECU 28, a suspension control unit 29, and a tachograph 30. Each of these components is operatively connected to the diesel ECU 4 by means of a bus system 32 which in this example comprises a CAN loop as described hereinabove. The units 26-30 are also electronic control units operatively connected to the diesel ECU 4.

The diesel ECU 4 will have an input to and receive an input from the units 26 to 30 in response to the first input signals 22 transmitted to the diesel ECU 4 by the sensors 18 and switches 20.

In order to control the timing and amount of diesel injected into the engine 6, the diesel ECU 4 transmits a plurality of first output signals 24 to the injectors 10, each injector receiving one of the plurality of first output signals 24. Each of the injectors 10 transmits a return signal 34 to the diesel ECU 4 once it has received a first output signal. This confirms to the diesel ECU 4 that the injector 10 is operating correctly.

Similarly, the diesel ECU 4 has an input to the operation of the components 26-30 by transmitting a bus signal 36 which is transmitted via the CAN loop bus system 32. Each of the units 26 to 30 is adapted to return a return signal 38 to the diesel ECU confirming that the system is operating correctly, and also requesting changes to the power of the engine according to system requirements, such as if the electronic braking system senses a road wheel spinning out of synchronisation with the others, it can request a power reduction to prevent the wheel from spinning.

Turning now to FIGS. 2 and 3, an engine assembly according to a first embodiment of the invention described in PCT patent application number PCT/GB2008/003188 is designated generally by the reference numeral 50. The engine assembly comprises components of the known engine assembly 2 illustrated in FIG. 1 and described hereinabove which components have been given corresponding reference numerals for ease of reference.

The engine assembly 50 comprises a first ECU in the form of diesel ECU 4 illustrated in FIG. 1, operatively connected to a plurality of first sensors 18 and switches 20. The diesel ECU 4 is further operatively connected to a plurality of diesel injectors 10 which are adapted to inject diesel into engine 6 under the control of the diesel ECU 4. The diesel ECU 4 is also adapted to have an input to further units within the engine assembly 26-30 by means of CAN bus system 32, as described herein above with reference to FIG. 1.

The engine assembly 50 further comprises a second ECU 54 which is operatively connected to, and has a controlling input from diesel ECU 4. Operatively connected to the second ECU 54 is a plurality of second sensors 56 which, in this embodiment, are adapted to measure: manifold pressure; coolant temperature; gas pressure and gas temperature. The engine system 50 further comprises a plurality of gas injectors 58, and a gas injector driver 60 both of which are operatively connected to the second ECU 54.

The engine system 50 further comprises a λ sensor 62 which is operatively connected to the second ECU 54 so as to form a closed loop input. The λ sensor 62 is a broad band oxygen sensor adapted to measure the oxygen content in the engine exhaust gases.

The second ECU 54 enables the engine assembly 50 to operate either in a first, diesel, mode or in a second mode in which the engine is fuelled by a gaseous fuel, typically methane, and diesel.

FIG. 2 shows the engine system 50 configured to operate in the first mode, and FIG. 3 shows the engine assembly 50 configured to operate in the second mode.

The engine assembly 50 will further comprise a trigger (not shown in FIG. 2 or 3) which will trigger the engine to switch from operating in the first mode to operating in the second mode. This will be described herein below in more detail with reference to FIG. 4.

When the engine assembly 50 is operating in the first mode the dual fuel feature of the engine is described as being in hibernation. Effectively, this means that the second ECU 54 has no effect on the operation of the engine assembly 50 as will also be described in more detail herein below.

Referring initially to FIG. 2, the engine system 50 is shown in the configuration which enables it to run in the first mode. When running in the first mode, the engine assembly 50 runs in a similar manner to the engine assembly 2 illustrated in FIG. 1 and described hereinabove.

The second ECU 54 is adapted to receive the first output signals 24 emitted by the diesel ECU 4 before those signals have been received by the diesel injectors 10.

When the engine system 50 is to run in the first mode, and the second ECU 54 is in hibernation, the first output signals 24 will be transmitted unmodified to the injectors 10 as they would in engine assembly 2. In addition, the second ECU 54 will transmit a return signal 64 to the diesel ECU 4 for each of the first output signals 24 emitted by the diesel ECU 4. This will inform the diesel ECU 4 that the diesel injectors are running correctly.

When the engine system 50 is to run in the second mode, i.e., on a mixture of methane and diesel, as shown in FIG. 3, the engine system 50 triggers the ECU 54 to operate in the second mode. The second ECU 54 will then modify the first output signal 24 from the diesel ECU 4 to produce first modified signals 66, and second calculated signals 68. The way in which the modified signals 66, 68 are produced will now be described in more detail. The first modified signals 66 are transmitted to the diesel injectors 10 and control injection of diesel into the engine 6. The second calculated signals are transmitted to the gas injector driver 60 which in turn uses these signals to control injection of methane into the engine 6 via the gas injectors 58. In the embodiment shown in PCT patent application number PCT/GB2008/003188 the gas injector driver 60 is separate from the second ECU 54. In other embodiments (not shown) the gas injector driver 60 may form an integral part of the second ECU 54.

The second ECU 54 comprises an emulator 70 which receives the first output signals 24 from the diesel ECU 4. In the embodiment shown the emulator 70 is an integral part of the second ECU 54. In other embodiments (not shown) the emulator 70 may be separate from the second ECU 54.

The emulator 70 will transmit a return signal 64 to the diesel ECU 4 corresponding to each of the first input signals 24 received from the diesel ECU 4. The return signals 64 will indicate to the diesel ECU that the engine is running as it would in the first mode. Thus from the point of view of the diesel ECU 4, the engine is running as normal, and the diesel ECU 4 communicates with components 22, 24, 26, 28 and 30 as it would do if the engine were running in the first mode.

The second ECU 54, on receiving the first output signals calculates the intended duration of diesel injection input that would be required to operate the engine 6 in the first mode based on the first output signals 24 . The second ECU 54 then modifies the first output signals 24 by reducing the pulse width of the signals to produce the first modified signals 66. First modified signals 66 of reduced pulse width are then transmitted to the diesel injectors 10 by the emulator 70. This means that the amount of diesel injected into the engine 6 will be reduced compared to the amount that would have been injected into the engine 6 had the engine been running entirely on diesel.

The second ECU then calculates the reduction in energy that will be supplied to the engine 6 by the reduced amount of diesel injected by the injectors 10. The second ECU then calculates the amount of methane that will have to be additionally injected into the engine 6 in order to ensure that the engine 6 receives substantially the same amount energy from both the diesel and the gas injected into the engine as would be the case if the engine were running in the first mode entirely on diesel.

The λ sensor (lambda sensor) 62 measures the amount of unburned oxygen in exhaust gases of the engine and transmits a signal 76 to the second ECU 54 which signal is dependent on the measured oxygen content.

Before producing the second modified signals 68 for transmission to the gas injector driver 60 which will drive the gas injectors 58, the second ECU 54 takes into account other variables.

One such variable is the oxygen content in exhaust gases measured by the λ sensor (lambda sensor) 62. It is not usual for OEMs to include a lambda sensor as part of the diesel engine control system, but it is considered necessary for a dual fuel engine.

Because the λ sensor 62 is connected to the second ECU by a closed loop, the second ECU 54 may continuously monitor the exhaust gas oxygen content and adjust the relative amounts of diesel and gas injected into the engine 6 to help ensure efficient running of the engine 6. The second ECU 54 may also control an air control valve to vary the amount of air entering the engine and hence the air to fuel ratio of the air/fuel mixture entering the engine, and so further ensure efficient combustion of the diesel and gas fuels. The gas will be injected at a different point in the engine cycle to the diesel. Is this limiting?

The second ECU 54 is also operatively connected to second sensors 56 which also transmit signals dependent on other engine parameters.

Each of the second sensors 56 emits a second input signal 74 which is received by the second ECU 54. The second input signals 74 are dependent on each of the variables measured by each of the second sensors 56.

The second ECU therefore takes into account the first input signals 24, the second input signals 74 and signal 76 from the λ sensor 62 when calculating the length of the first modified signals 66 and second calculated signals 68. The second calculated signals 68 are transmitted by the second ECU 54 to the gas injector driver 60 which controls each of the gas injectors 58 in accordance with the instructions received via the second calculated signals 68.

By means of the invention described in PCT patent application number PCT/GB2008/003188 it is possible to retro fit the second ECU 54, the gas injector driver 60, λ sensor 62 and second sensors 56 to an existing engine assembly 2 adapted to be fuelled by diesel only in order to produce an engine assembly 50 which is able to operate in a first mode in which it is fuelled by diesel, and a second mode in which is it fuelled by methane or a mixture of diesel and methane.

Turning now to FIG. 4, the operation of the engine will be described with reference to a flow chart 80.

Parts of the engine assembly 50 that correspond to the engine system described with reference to FIGS. 2 and 3 have been given corresponding reference numerals for ease of reference.

When the engine is initially started at start 82, the diesel ECU will cause the engine to operate in the first mode in which it is fuelled entirely by diesel.

In order to ensure that the engine 6 is running as efficiently as possible, the diesel ECU receives first input signals 22 from first sensors 18, switches 20, and driver controls 84. The diesel ECU then transmits a plurality of first output signals 24 to the diesel injectors 10, based on the input signals 22 received from the first sensors 18, switches 20, and driver controls 84.

The engine thus operates in the first mode, and the second ECU 54 is effectively in hibernation. As the engine continues to be operated, the second ECU 54 will monitor certain parameters such as engine temperature 86, gas vapour temperature 88, gas vapour pressure 90 and a manual hibernation switch 92. Each of these sensors together with switch 92 is operatively connected to the second ECU 54. In this example, the second ECU will monitor whether the engine temperature is above or below a predetermined lower limit. If the engine temperature is below the predetermined lower limit the second ECU 54 will remain in hibernation and the engine will continue to run in the first mode.

If the engine temperature is above the predetermined lower limit the second ECU 54 will then determine whether the gas vapour pressure is within a predetermined limit. If the gas temperature is not within predetermined limits the engine will continue to run in the first mode.

If the gas vapour temperature is within the predetermined limits, the second ECU 54 will determine whether the gas vapour pressure is within predetermined limits. If the gas vapour pressure is not within predetermined limits, the engine will continue to run in the first mode.

If the gas vapour pressure is within predetermined limits the second ECU 54 will determine whether the manual hibernation switch 92 is switched on or off. If it is on, then despite the fact that the variables measured by sensors 86, 88 and 90 are within predetermined limits or in the case of the engine temperature above a predetermined lower limit, the engine will continue to run in the first mode. If however the hibernation switch 92 is off then the engine system will be triggered to run in the second mode. In this case the second ECU will carry out an energy calculation to calculate the required ratio of gas/diesel that must injected into the engine in order to ensure that the engine has appropriate energy input as described hereinabove. This will result in first modified signals 66 being produced by the second ECU 54. The first modified signals 66 control diesel injectors 10.

The second ECU will also receive signals from second sensors 56 which in this embodiment measure the absolute manifold pressure, gas vapour pressure, gas vapour temperature, engine temperature and air to fuel ratio. The measured variables measured by second sensors 56 will result in the second ECU 54 calculating the amount of gas that should be injected into the engine by the gas injectors 58, and producing the second calculated signals 68 which are emitted to the gas injector driver 60 which in turn drives the gas injectors 58.

In the operating system described above in relation to FIGS. 1 to 4 it will be appreciated that when fitting the system to an existing vehicle it is necessary to disconnect the wire connections to the injectors 10 from the first, OEM ECU 4 and instead connect the injectors 10 to the second ECU 54. The connection wires from the ECU 4 which have been disconnected from the injectors 10 may be connected to one or more injector emulation devices so that the ECU 4 receives an appropriate return signal 64 in order to be ‘fooled’ into thinking it is still connected to the original injectors 10, and so continue to operate correctly.

The present invention is concerned with such injector emulation devices which are particularly suited for use in the operating systems of FIGS. 1 to 4.

According to one aspect of the present invention there is provided an injector emulation device for incorporation into a multiple fuel engine control system, the system including a first control device configured to operate a plurality of fuel injectors to inject a first fuel into selected cylinders of the engine when the system is operating on the first fuel only and a second control device arranged to operate, instead of the first control device, said plurality of injectors to inject said first fuel when the system operates in multifuel mode, said first control device being connected to an injector emulation device for operation during said multifuel mode, said injector emulation device including an electrical load device arranged to mimic the electrical load characteristic of the injector being emulated and further including electronic means which mimic the inductance and flyback characteristics of the injector being emulated.

According to a first embodiment of the present invention, the emulation device includes first and second electrical terminals for connection to the first control device, and further includes circuitry defining a primary current flow path between said first and second terminals, said load device being arranged to control current flow along said primary current flow path.

According to a second embodiment of the present invention, the emulation device includes switch means arranged to be operably connected between the first control device and a plurality of injectors which are to be emulated, the switch means, on operation of the first control device to operate a given one of the injectors, being operable to switch the first control device to operate a preselected one of the remaining injectors.

In the second embodiment, the first control device is arranged to operate a remaining one of the injectors and so it is this one of the injectors which acts to emulate the given one of the injectors.

Various aspects of the present invention are hereinafter described with reference to the accompanying drawings, in which:

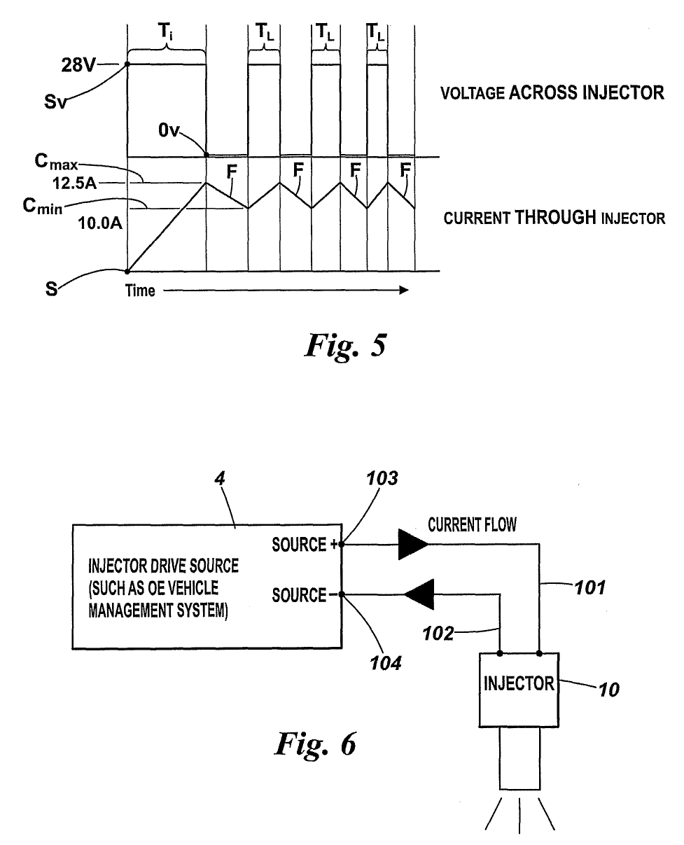

FIG. 5 is a graphic representation of voltage applied across and current flowing through an injector;

FIG. 6 is a schematic diagram showing a typical connection between an injector and electrical drive source;

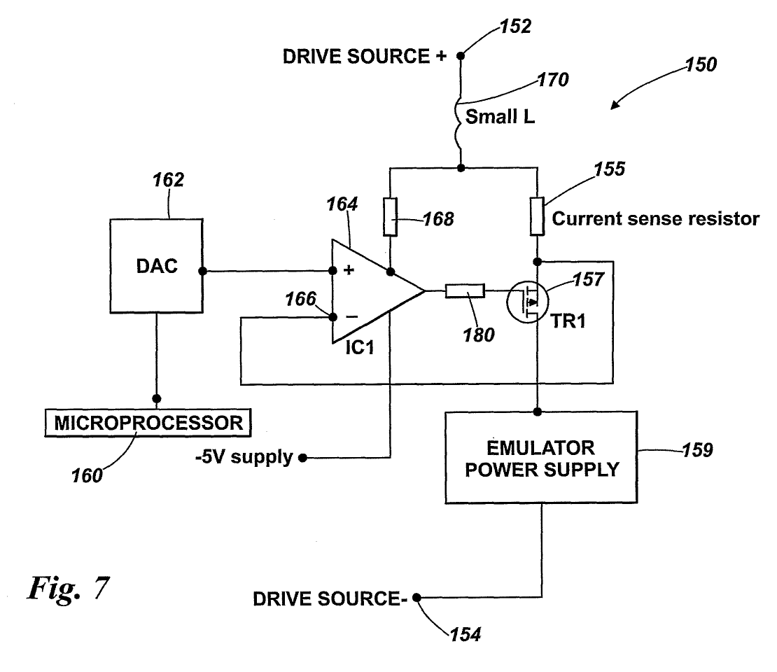

FIG. 7 is an electrical diagram showing the circuit layout of an injector emulation device according to a first embodiment of the present invention;

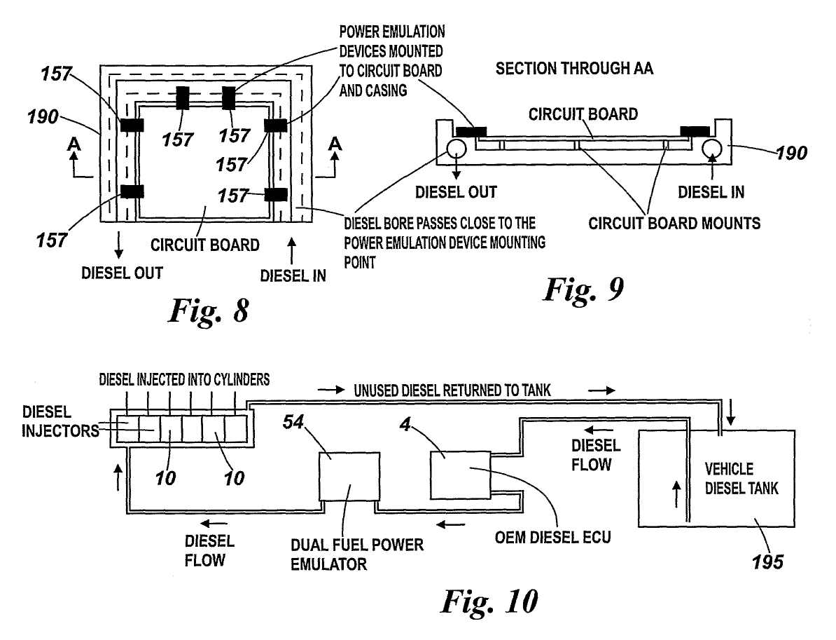

FIGS. 8 to 10 are schematic representations of a system comprising a plurality of the emulator devices illustrated in FIG. 7;

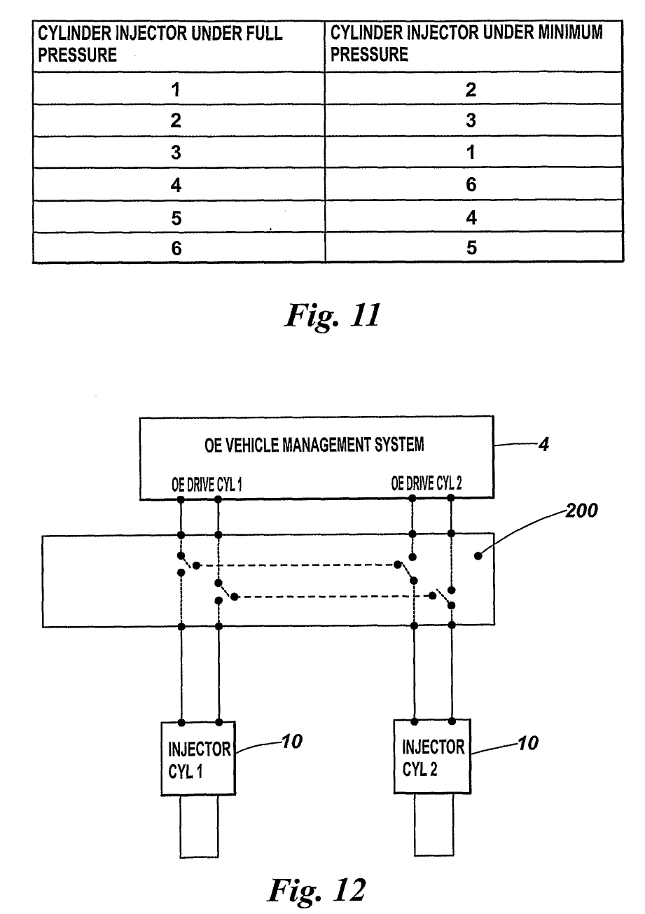

FIG. 11 is a table illustrating a typical sequence of fuel pressurisation in a 6 cylinder diesel engine;

FIG. 12 is a schematic diagram illustrating the principle of operation of an injector simulation device according to a second embodiment of the present invention;

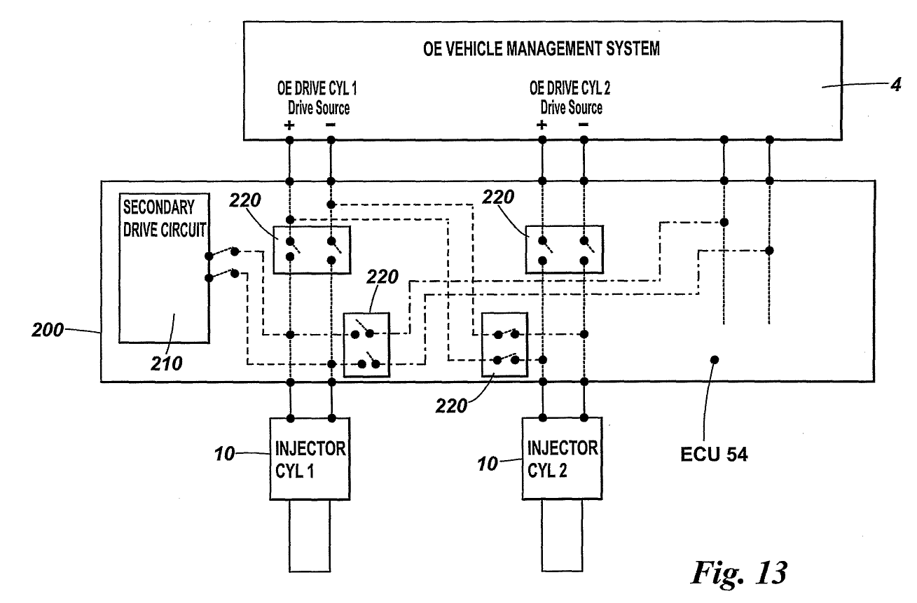

FIG. 13 is a similar diagram to FIG. 12 illustrating a further modification to the second embodiment;

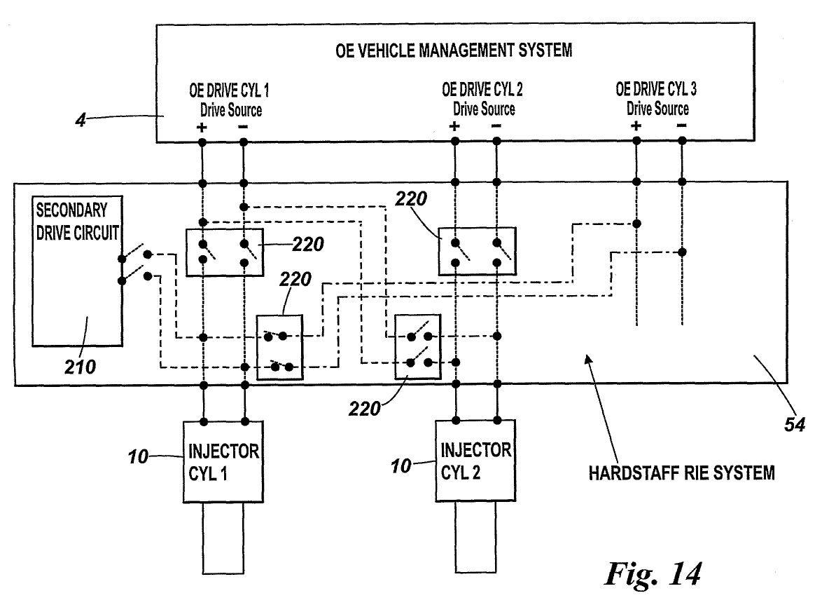

FIG. 14 is a similar diagram to FIG. 13 showing the device in a different operating mode; and

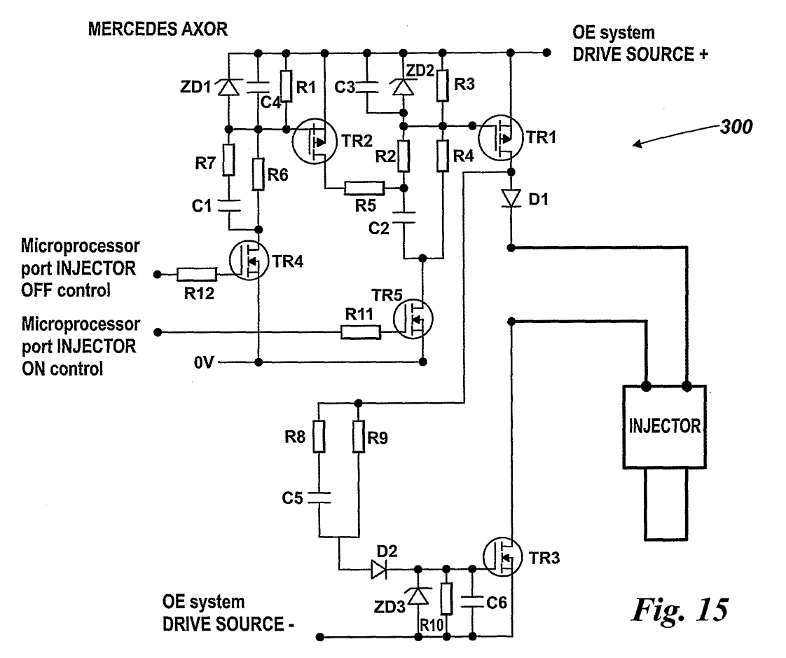

FIG. 15 is a circuit diagram of a device according to the second embodiment of the present invention.

The preferred embodiments of the present invention are arranged to mimic the current flow the ECU 4 would expect to see when activating a selected injector 10.

In this respect, as exemplified in FIG. 6, an ECU 4 is connected to an injector 10 via a first wire 101 and a second wire 102. The first wire 101 is connected to a positive terminal 103 of the ECU 4 and the second wire is connected to a negative terminal 104. The injector 10 includes a solenoid (not shown) which when supplied with electrical current opens the injector 10 to cause injection of fuel into an associated engine cylinder for a predetermined period of time determined by the ECU 4.

The illustrated example is based upon a diesel engine system in a commercial vehicle; with such a vehicle the power source will typically be 28 volts.

When the ECU 4 activates a selected injector 10 to supply fuel to a selected cylinder of the engine it monitors the variation in current flow through the solenoid of the injector and compares that to a predicted current flow pattern stored in memory; if the monitored flow pattern is as predicted in the memory, then the ECU 4 will operate normally on the basis that the injector is acting normally.

The typical current flow pattern through a solenoid of a normally operating fuel injector 10 is represented in the graphic diagram of FIG. 5.

Initially there is no voltage applied across the solenoid of the injector 10 and so there is no current flow (this is point S on the graph).

The ECU 4 activates the injector 10 by first switching the positive terminal 103 to the power source (i.e. the battery source in a vehicle) and simultaneously switching terminal 104 to 0 volts (i.e. ground on the vehicle); this applies in the present example a voltage of 28 volts across the solenoid of the injector 10. Simultaneously switching terminal 104 covers the situation where terminal 104 is switched at the same time as terminal 103 or a few microseconds later. This in effect switches ‘on’ the solenoid for the first time in the injection sequence for the injector 10 and is represented in the voltage graph as point Sv.

The ECU 4 maintains the solenoid switched on for a first period of time (represented as Ti) after which time the solenoid is switched off by disconnecting terminal 103 from its power source or by disconnecting terminal 104 from ground. This causes the applied voltage to drop to zero and is represented on the graph as point Ov.

When the solenoid is initially switched on (point Sv), current starts to flow and the flow progressively increases to reach a predetermined maximum current value (level Cmax on the current graph). In the illustrated example, the maximum current value Cmax is shown as 12.5 A. As seen in the graph, the current rate of flow ramps up from point S to level Cmax over the period of time Ti; it does not instantly jump from zero to Cmax. This is due to the solenoid coil first storing electrical energy as an increasingly greater magnetic force is built up. Once a sufficiently strong magnetic field produced by the solenoid has built up, the solenoid will cause the injector 10 to open (i.e. inject fuel). The ramping up of the electrical current flow over the initial period Ti is generally referred to as the inductive (or ‘L’) characteristic of an injector and will always be present in a normally operating injector.

The solenoid is switched off after the initial time period Ti since continuance of application of the voltage could cause current flow to continue to rise and cause damage to the solenoid coil. However, there is the requirement to maintain the injector open for a sufficient period of time in order to inject the required amount of fuel and this is achieved by repeatedly switching on and off the solenoid for predetermined periods of time (Th). Switching on and off of the injector solenoid is done under the control of the ECU 4 monitoring the current amperage flowing through the solenoid; in the initial phase of operation, when the monitored amperage reaches Cmax (12.5 A in the present example) the ECU 4 switches off the solenoid until the monitored current amperage reaches a predetermined minimum Cmin (this is shown as 10.0 A in the current example).

When Cmin is reached the ECU 4 switches the solenoid back on. This initial sequence of switching on and off the solenoid (by triggering the switch on/off at monitored amperage values of 12.5 A and 10.0 A) is continued over a predetermined period of time, typically 1 ms. Thereafter, the triggering of the switching on/off is changed to lower values (not shown in FIG. 5), typically switching off at 8.5 A and switching on at 6.0 A. This switching on/off of the solenoid is generally referred to as the hold phase for the injector.

It will be seen in the current graph that each time the solenoid switches off current continues to flow as the magnetic force generated by the solenoid coil collapses; this flow of current is designated as F on the graph and is a predicted characteristic of the injector generally referred to as ‘flyback’. The ECU 4 monitors this flyback characteristic and compares it with a predetermined flyback characteristic stored in its memory; if the monitored flyback characteristic is as predicted in its memory, the ECU 4 will act as though the injector is acting normally.

Also it will be seen in FIG. 5 that the periods of time over which the solenoid is switched on progressively decreases with time. This is because the inductance characteristic of the injector solenoid changes after the injector has been opened and fuel starts to be injected. The ECU 4 also monitors the changing time periods of switching on the solenoid and compares the monitored changes with predetermined changes stored in memory. If the monitored changes in time are as predicted in memory, the ECU 4 will act as though the injector is acting normally. For example, an abnormal situation would be a clogged injector; in this situation the inductance (and hence the changing periods of time for switching on the injector) would be different to the predetermined changes of time stored in memory and the ECU 4 would register that the injector was faulty.

In addition to the above, the driver within ECU 4 will be allowed to break down at the point of injector solenoid turn off. The injector solenoid will exhibit an excursion into the region of 55V, limited by the break down characteristic of the driver within ECU 4. Allowing the solenoid to reach a relatively high voltage compared with that of the drive source will cause rapid diminishing of the magnetic field within the solenoid, and so ensure rapid closure of the injector 10.

The embodiments of the present invention aim to provide a solution to the problem of disconnecting the ECU 4 from the injectors 10 it has been designed to operate and monitor and instead connect it to emulation devices which operate in a manner which complies with the expected performance of the original injectors the ECU 4 is designed to operate and monitor. In this way the ECU 4 operates normally in the manner it was designed to do despite being incorporated into and operating within a system it was not originally designed to do.

In accordance with a first embodiment of the present invention there is provided an injector emulation device in the form of an electrical device 150 which is arranged to simulate the operation of the solenoid of an injector.

In this respect the device 150 is arranged to operate to emulate the current flow patterns (as seen in FIG. 5) which the ECU 4 expects to monitor when connected to an original injector 10 (i.e. to an injector 10 which it is programmed to operate and monitor). In particular, the device operates to consume electrical energy to mimic a solenoid coil and provides a flowback of current when being switched off to mimic the flyback characteristic of the injector. The device 150 also operates to cause the ECU 4 to vary the rate of switching on/off of the device in a manner it would do if connected to the original injector 10.

The circuit diagram of an example of a suitable electrical injector emulation device according to the first embodiment of the invention is shown in FIG. 7. In practice it is envisaged that there will be several devices 150 acting in parallel so that the generated heat can be handled effectively.

The circuit includes a positive input terminal 152 for connection to the positive terminal 103 of ECU 4 and a negative terminal 154 for connection to the negative terminal 104 of ECU 4. There is a primary current flow path between input terminal 152 and output terminal 154 via a current sense resistor 155, a selectively variable electrical load device 157 for controlling current flow between terminals 152 and 154, and a supplementary DC power supply 159.

A control circuit is provided for controlling the load device 157; the control circuit includes a microprocessor 160, a digital to analogue converter (‘DAC’) 162 and an operational amplifier 164. A negative input terminal 166 of the amplifier 164 is connected to the circuit in between the current sense resistor 155 and the load device 157. The amplifier 164 is also connected to the positive input terminal 152 via a resistor 168 and by virtue of this connection the amplifier is able to sense the voltage drop across resistor 155.

When the ECU 4 initially activates the emulation device 150, operating voltage (28V in the current example) is applied across terminals 152, 154. This ‘switch on’ across terminals 152,154 triggers the microprocessor into operation and causes the microprocessor to initiate a sequence of current ramping control output signals which are fed to the DAC 162. The DAC 162 operates the load device 157 to vary the current flow along the primary current flow path to increase from a minimum value to a maximum value.

When the ECU 4 senses the minimum current value it switches on the device 150; when it senses the maximum current value it switches off the device 150. The microprocessor is programmed to reproduce the ramping up of the current flow at each switch on to mimic that of the injector which is being simulated and so replicates the inductance characteristic of the injector.

The load device 157 when conducting current flow along the primary flow path consumes electrical energy and dissipates the energy in the form of heat. In order to maintain its operating temperature at a desired predetermined level, the load device 157 is preferably mounted on a force cooled heat exchanger 190, which in this embodiment comprises the casing of ECU 54 as shown in FIGS. 8 to 10. Preferably, fuel flowing between the injectors 10 and fuel supply source 195 (on the feed and/or return flow paths) is used as the coolant for the load device 157. The load device 157 is chosen to consume electrical energy at the rate expected by the injector being emulated.

In the embodiment illustrated in FIGS. 8 to 10 there is a plurality of emulation devices 150 acting in parallel, each device 150 comprising a load device 157. The load devices 157 are each mounted on force cooled heat exchanger 190, which in this example comprises the casing of the ECU 54.

A suitable load device for use in a commercial vehicle having a 28V power supply is a 100V rated P channel enhancement mode MOSFET (Metal Oxide Semiconductor Field Effect Transistor). For example, such a device could be type IRF5210 (selected from the International Rectifier HEXFET generation). However it will be appreciated that other devices could be used as the load device 157, for example an N channel MOSFET, an IGBT (Insulated Gate Bipolar Transistor) or a bipolar transistor.

When the ECU 4 switches the device 150 off, it is necessary for the device 150 to produce the requisite flyback characteristic. The supplementary power supply 159 is used to provide the required current flow back to the ECU 4, whilst the ECU 4 disconnects the 28V drive source at terminal 152 to control the current in the system by Pulse Width Modulation (PWM). The device 150, under the control of microprocessor 160, will then provide the negative current ramp shown as Ramp F in FIG. 5. The microprocessor is triggered into this mode when it monitors disconnection of the 28V drive source at terminal 152 by ECU 4.

It is envisaged that instead of incorporating a supplementary power supply 159 for providing the current for the simulated flyback characteristic (during ramp F), an alternative could instead be incorporated in the primary flow path. An electrical device, such as a capacitor, could be used to serve this purpose, as an alternative to a power supply, to provide electrical energy during periods when the device 150 is switched into RAMP F.

The small inductor 170, shown in the circuit of FIG. 7, serves to filter out the small ripple effects in current comprising undesirable control oscillation when more than one electrical device 150 is used in parallel. Small inductor 170 prevents this oscillation and thus prevents the ripple.

The inductor 170 has been carefully designed to provide the flyback voltage spike function at the end of the simulated injection cycle, and also to provide a means for preventing undesirable control oscillation between the individual devices forming the device 150.

Ramp F is a rapid diminishing profile. This will cause the inductor 170 to create a voltage spike in the system in the same way as a normally operating injector would. The inductor 170 provides a 55V spike at final switch off of device 150 by the ECU 4.

Device 150 further comprises a resistor 180 which is used to help control the gain of circuit 150 and to protect the operational amplifier 164.

In accordance with a second embodiment of the present invention the emulation device takes the form of a switching device for use with diesel engines running under the Unit Pump Electronically Controlled (UPEC) system. In a UPEC system, only the injector associated with a given cylinder is fully pressurised at any one time; the injectors associated with the other cylinders have fuel cavities containing fuel under a pressure somewhere between zero and full pressure. An injector will only inject fuel into its associated cylinder when fuel in its cavity is under full pressure. In accordance with the second embodiment of the invention, this fact is taken advantage of in order to emulate the injector which the ECU 4 believes it is operating.

The general principle underlying the second embodiment is that when it is required to run the engine in the dual fuel mode, the switching device of the second embodiment switches the connections between the ECU 4 and the bank of injectors 10 such that the ECU 4 functions to operate an injector having a fuel cavity below full pressure whilst the secondary ECU 54 operates the injector 10 associated with the firing cylinder.

In FIG. 11 a table is shown for a 6 cylinder diesel engine operating in a UPEC system. In the table it will be seen in the left hand column that a firing sequence is represented in that cylinders 1 to 6 fire in succession; this means that the injectors associated with these cylinders are pressurised in the same sequence. At the same time, injectors associated with the non-firing cylinders successively move through a sequence wherein the pressure in their fuel cavities is at a minimum value; this sequence is represented in the right hand column in FIG. 11.

For example, it will be seen from the table that when the injector associated with cylinder 1 is at full pressure, the injector associated with cylinder 2 is at minimum pressure. In principle therefore, when the ECU 4 operates to control the injector associated with cylinder 1, the switching device of the present invention operates to switch the connection from the ECU 4 to the injector associated with cylinder 2. This is shown diagrammatically in FIGS. 12 to 14, the switching device being designated by the number 200. The switching device 200 comprises a secondary device circuit 210 and a plurality of switches 220.

When the switching device 200 operates to switch the connection with the ECU 4 from the injector associated with cylinder 1 to the injector associated with cylinder 2, the injector associated with cylinder 1 is now driven by secondary drive circuit 210 (FIG. 13) so that this injector can be operated to inject the desired amount of the first fuel for dual fuel operation.

It will also be seen from FIG. 14 that when the injector associated with cylinder 3 is at full pressure, the injector associated with cylinder 1 is at minimum pressure. Accordingly the switching device of the present invention also needs to switch the connection from the ECU 4 from the injector associated with cylinder 3 to the injector associated with cylinder 1.

The arrangement of switches to effect the above switching operations is diagrammatically illustrated in FIGS. 13 and 14.

FIG. 13 illustrates the situation where the ECU 4 operates to control the injector associated with cylinder 1 but is instead connected to operate the injector associated with cylinder 2. On operation of the cylinder 2 injector, the ECU 4 will receive electrical feedback from that injector and will believe it is operating the injector of cylinder 1 correctly. The ECU 4 will therefore operate normally. FIG. 13 also indicates that the ECU 54 is connected to the injector of cylinder 1 and operates that injector in accordance with the programme of ECU 54. In the condition illustrated in FIG. 13, there is no electrical connection to the injector associated with cylinder 3.

The switching devices 220 are shown as solid boxes enclosing two switches. The conventional switch symbols within the boxes are shown for simplicity. However in this embodiment each switch 220 comprises the circuit shown in FIG. 15. Not shown at this level are three additional connections for each switching device 220, one to battery ground (0V) and two microprocessor control inputs.

FIG. 14 illustrates the condition where the ECU 4 operates to control the injector of cylinder 3. In this condition, the switching device 200 of the present invention switches the connection with the ECU 4 from the injector of cylinder 3 to the injector of cylinder 1 and (although not shown in FIG. 14), instead connects the injector of cylinder 3 to a secondary drive circuit 210 that will instead control injector 3.

In will be appreciated from the above that in one complete firing cycle of the engine the injector for a given cylinder operates once to inject fuel under the operation of the ECU 54 and once, as an emulation injector, under the operation of the ECU 4. The arrangement for the injector of cylinder 1 is shown in FIGS. 13 and 14; a similar arrangement would be provided for the injectors associated with the other cylinders 2 to 6.

A specific example of an electronic circuit for a switch 220 is illustrated in FIG. 15; this example is particularly suited for a Mercedes Axor system.

This circuit is used to transfer the pulse-width modulated (PWM) drive intended for an injector 10 from a drive source, such as a first ECU 4, to an injector associated with a cylinder at minimal pressure.

A switch 220 may contain multiple duplications of this circuit according to the number of injectors to be emulated.

There are two applications of this circuit 300 per injector 10 within ECU 54. The term drive source is the OE drive from ECU 4, to route the OE drive from the input of ECU 54 to the injector being used as an emulator when in dual fuel mode, or when purely in diesel, to the injector intended by the OE designer. In dual fuel mode, the injector passing diesel into the engine would be controlled by the secondary drive circuit 210. There is one secondary drive circuit 210 per injector 10 within ECU 54. These circuits 210 serve to control the injector under command from the main dual fuel microprocessor within ECU 54 to deliver a lower amount of diesel to the engine than intended by the vehicle OE system.

Different injector sequences may be necessary dependant on the architecture and strategy used by the OEM.

Each switch 220 is essentially a fast electronic double pole switch designed specifically for the purpose described above. The switching device 220 has two different microprocessor control inputs, two input connections from the vehicle OE system drive source and two outputs to an injector 10.

The device selected in position TR1 is a P channel Enhancement mode MOSFET (Metal Oxide Semiconductor Field Effect Transistor). The actual device selected is from the International Rectifier HEXFET generation, type IRF5210. It is through this device that current flows, or is prevented from flowing, from the OE system drive source + to the injector 10 positive terminal via a blocking diode D1.

TR3 is an N channel MOSFET of the International Rectifier HEXFET generation of devices, and is as the main switch for the negative (−) side of the injector drive. It is through this device that current flows, or flow is prevented from flowing, from the injector negative terminal back to the OE system drive source (−). The type selected is the IRL3705N

The two devices, TR1 and TR3, are intended under all conditions to act as a pair, providing a double pole switch function.

This design has been optimised for the Axor, although there would be other ways of achieving it using IGBT (Insulated Gate Bipolar Transistors) or even bipolar transistors.

The components within the electronic circuit are enabled and disabled under microprocessor control. A logic high from the microcontroller at the ON control, R11, turns on TR1 rapidly by capacitively coupling TR1 gate to 0V through C2, R2 and TRS. R2 serves to limit the peak current at this point, whilst ZD2 clamps the gate-source voltage of TR1 limiting it to approximately 13V. R4 then keeps TR1 turned ON after C2 has charged. R4 also serves to discharge C2 during the OFF phase.

Once TR1 is turned ON and the drive source voltage appears at the drain, TR3 is also turned ON by similar action through C5, R8, R9 and ZD3. The path for the return current is through the ‘Drive source’. C6 Serves to hold the gate voltage keeping TR3 turned ON during the PWM OFF phases of the injector drive cycle. Diode D2 prevents C6 from becoming discharged keeping TR3 turned ON. The time constant of R6 and R10 is approximately 20 ms which provides sufficient time to handle the turn OFF phase of the injector drive.

TR2 is used to rapidly turn OFF TR1 if required (for instance in the case of a fault being detected). TR2 is turned on by ‘microprocessor port OFF control ‘being set to logic HIGH by the microprocessor, turning OFF TR1.

D1 is used to prevent current intended for the injector from another drive source back feeding through TR1 preventing proper operation.

1. An injector emulation device for incorporation into a multiple fuel engine control system, the system including a first control device configured to operate a plurality of fuel injectors to inject a first fuel into selected cylinders of the engine when the system is operating on the first fuel only and a second control device arranged to operate, instead of the first control device, said plurality of injectors to inject said first fuel when the system operates in multifuel mode, said first control device being connected to an injector emulation device for operation during said multifuel mode, said injector emulation device arranged to mimic the electrical load and flyback characteristics of the injector being emulated, wherein, when the system is operating on the first fuel only, the first control device is adapted to operate a firing injector having a fuel cavity at maximum pressure, and when the system is operating in the multifuel mode, the second control device is adapted to operate the firing injector, the injector emulation device further comprising switching means for switching the first control device such that it operates a different injector when the system is running in the multifuel mode.

2. An injector emulation device for incorporation into a multiple fuel engine control system, the system including a first control device configured to operate a plurality of fuel injectors to inject a first fuel into selected cylinders of the engine when the system is operating on the first fuel only and a second control device arranged to operate, instead of the first control device, said plurality of injectors to inject said first fuel when the system operates in multifuel mode, wherein each injector; has a cylinder associated therewith; comprises a fuel cavity; and is adapted to run under a unit pump electronically controlled (UPEC) system in which, at any given time during operation, each injector has a different pressure within its fuel cavity with the fuel cavity of only one injector having a maximum pressure at any given time, wherein each injector is adapted to inject fuel into its associated cylinder only when its fuel cavity is at the maximum pressure, wherein when the system is operating on the first fuel only, the first control device is adapted to operate the injector with a fuel cavity at maximum pressure, and when the system is operating in the multifuel mode, the secondary control device is adapted to operate the injector with a fuel cavity at maximum pressure,
the injector emulation device further comprising a switch for operably connecting the first control device to a different injector when the system is operating in the multifuel mode, which injector was a fuel cavity at a pressure that is below maximum pressure.

3. An injector emulation device according to claim 1 further including additional switch means arranged to connect the second control device to a different injector.

4. (canceled)

5. An injector emulation device for incorporation into a multiple fuel engine control system, the system including a first control device configured to operate a plurality of fuel injectors to inject a first fuel into selected cylinders of the engine when the system is operating on the first fuel only and a second control device arranged to operate, instead of the first control device, said plurality of injectors to inject said first fuel when the system operates in multifuel mode, said first control device being connected to an injector emulation device for operation during said multifuel mode, said injector emulation device including an electrical load device arranged to mimic the electrical load characteristic of the injector being emulated and further including electronic means which mimic the inductance and flyback characteristics of the injector being emulated.

6. An injector emulation device according to claim 5 including first and second electrical terminals for connection to the first control device, and further including circuitry defining a primary current flow path between said first and second terminals, said load device being arranged to control current flow along said primary current flow path.

7. An injector emulation device according to claim 6 further including load device control circuitry for controlling the load device to control current flow along said primary current flow path in a predefined manner to replicate current flow through the injector being emulated.

8. An injector emulation device according to claim 7 including a microprocessor connected to the load device, the microprocessor being programmed to control the load to produce current flow along the primary flow path in said predefined manner.

9. An injector emulation device according to claim 8 wherein the microprocessor is connected to said load device via a digital to analogue converter and an amplifier.

10. An injector emulation device according to claim 9 wherein an electrical resistor is located in the primary current flow path upstream of the load device, the amplifier being arranged to sense voltage drop across the resistor and being arranged to control the load device to alter current flow along the primary current flow path in response to said sensed voltage drop.

11. An injector simulation device according claim 6 wherein the load device is transistor.

12. An injector emulation device according to claim 7 wherein the transistor is a P channel MOSFET.

13. An injector emulation device according to claim 11 or 12 including cooling means operable on the load device.

14. (canceled)

15. A multiple fuel engine control system, the system including a first control device configured to operate a plurality of fuel injectors to inject a first fuel into selected cylinders of the engine when the system is operating on the first fuel only and a second control device arranged to operate, instead of the first control device, said plurality of injectors to inject said first fuel when the system operates in multifuel mode, said first control device during said multifuel mode being connected to an injector emulation device according to claim 1.
